(19) United States
(12) Patent Application Publication
(10) Pub. No.: US 2025/0330109 A1
(43) Pub. Date: Oct. 23, 2025

(54) MONITORING A SYNCHRONOUS MOTOR

(71) Applicant: Innomotics Gmbh, Nürnberg (DE)

(72) Inventors: Julia Hofmockel, Rosstal (DE); JOHANNES ENDRES, Königsberg (DE); SASCHA DUMKE, Nürnberg (DE); JENS WINTER, Hessisch Lichtenau (DE)

(73) Assignee: Innomotics Gmbh, Nürnberg (DE)

(21) Appl. No.: 18/870,582

(22) PCT Filed: Apr. 14, 2023
(86) PCT No.: PCT/EP2023/059739

§ 371 Date: Nov. 29, 2024

(30) Foreign Application Priority Data
May 30, 2022 (EP) 22176168.7

(51) Int. Cl. H02P 29/024; H02P 25/022

(52) U.S. Cl. CPC H02P 29/024; H02P 25/022

(57) ABSTRACT

In a method for monitoring a synchronous motor, in particular for monitoring an excitation device of the synchronous motor, an Individual value dependent on the power factor of the synchronous motor is measured. A monitoring value is formed from a multiplicity of individual values and/or values dependent thereon. The method can be carried out by a monitoring device.

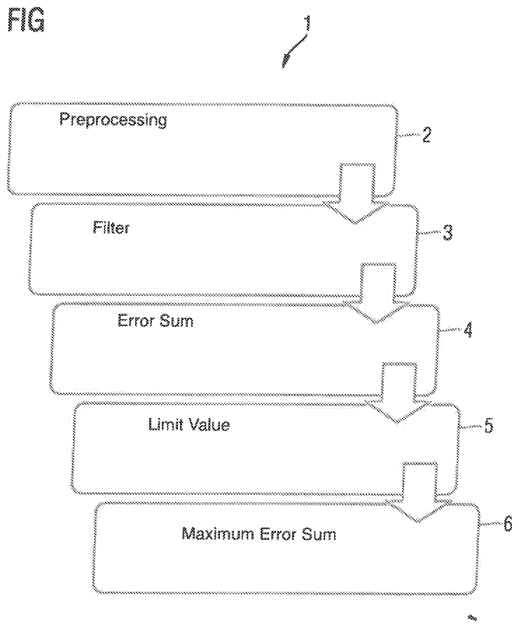

The invention relates to a method or a facility for monitoring a synchronous machine, in particular a method or a facility for monitoring an excitation facility of a synchronous machine. In particular, the invention relates to a method for identifying a faulty excitation facility in the case of a synchronous motor in the mains or converter operation, wherein the mains operation is also referred to as a DOL operation (direct switch on at the mains).

Synchronous machines are electrical machines which can be used as a synchronous motor or as a synchronous generator. Synchronous machines can be self-excited or externally excited. Externally-excited synchronous machines have an excitation facility. Self-excited synchronous machines have in particular permanent magnets for the excitation. When operating the synchronous machine, attention must be paid to the power factor. The power factor (also called the effective power factor) is the ratio of the amount of effective power P to the apparent power S in alternating current technology. In the case of sinusoidal alternating variables, the effective factor is defined from the ratio of the effective power P to the apparent power S. This is also referred to as cos φ. The power factors in the case of synchronous motors in mains or converter operation can be adjusted or set by the excitation facility. In general, a power factor of 1 can be assumed, since this is the optimum value from the point of view of losses and the provision of torque. In principle, the motor can also be operated at other operating points, but this must be taken into account in the algorithm (variable or static target value specification of the power factor). It is often not possible to optimize the settings of the excitation circuit during the commissioning phase, since it is not possible to access all points during the trial operation. A sub-optimal setting is not immediately problematic for the operator if the performance in terms of torque is sufficient. In this case, the excitation closed-loop control circuit can . . . be viewed as rather secondary under certain circumstances. A faulty or incorrectly parameterized excitation facility or defective excitation facility in particular leads to anomalies in the power factor.

An object of the invention is to identify a fault, an anomaly or a defect. The fault or faults concern in particular a faulty and/or incorrectly parameterized excitation facility and/or a defective excitation facility. The object concerns in particular a synchronous motor.

The object is achieved according to a method according to claim 1, a monitoring facility according to claim 11 or a computer program product according to claim 12.

In the case of a method for monitoring a synchronous machine, in particular a synchronous motor, in particular for monitoring an excitation facility of a synchronous machine, in particular of a synchronous motor, a single value dependent on the power factor of the synchronous machine or synchronous motor is measured, wherein a monitoring value is formed from a multiplicity of single values and/or dependent values. The single value is therefore the power factor itself, for example. The single value can also be formed from a multiplicity of single values. An anomaly can be automatically identified by monitoring single values and forming a monitoring value from the single values. This is also possible during long-term operation of the synchronous machine. When monitoring over a long period, it is therefore in particular not the power factor from one mains period to the next that is monitored, but over longer periods of minutes, hours, days, weeks or months. This makes it possible to automatically identify anomalies during long-term operation, for example of a synchronous motor with an excitation facility. A ‘normal’ or ‘abnormal’ status that describes the prevailing health of the excitation facility can be made available. The potential for savings alone of the losses is in the range of 50,000 kWh per year in the case of larger motors. There is a considerable savings potential over the life cycle. Monitoring is therefore particularly important in the case of synchronous machines with a higher output of several hundred kilowatts or a few megawatts.

A long-term recording of the excitation values of synchronous motors can result in an automated evaluation of the power factor or renders it possible. Anomalies can be automatically determined within a short time. A change (for example repair) to the excitation facility, for example, is also automatically identified on the basis of the data. The error status, for example, is reset accordingly.

The monitoring value is, in particular, a difference between a target value for the power factor and the determined power factor or not from it. The determined power factor is an example of a single value. The monitoring value can be determined as follows, for example. In a period of time, power values L1 to L10 are determined at time intervals. Furthermore, for example, a target power value L-target of 1 is specified, wherein other target values can be set for the power value (for example 0.9). A first intermediate monitoring value ZW1 is obtained from L-target minus L1, (L-target−L1=ZW1). L-target minus L2 results in a second intermediate monitoring value ZW2. A total error sum W is obtained by an addition of the intermediate monitoring values ZW1 to ZW10. The total error sum W can be regarded as a monitoring value.

Automated monitoring can eliminate the need for experts to manually monitor the power factor. For example, a time series analysis at irregular time intervals can be used to assess the prevailing state of health. For monitoring purposes, static limit values can also be set for the power factor in a particular configuration, although this can lead to false indications at some operating points. In a static analysis, for example, a fixed limit value is determined and a warning is issued if the power factor is below it. Errors can also occur in a manual evaluation of the limit values over time. This means that very specific expert knowledge is required, which in turn requires a high level of data aggregation. An analysis can be associated with a high level of personnel costs. In the case of manual monitoring, very long periods of operation have to be observed manually during operation and evaluated with regard to the exclusion criteria. This problem can be overcome by creating a monitoring value, wherein the monitoring value is formed from a multiplicity of single values or depends on them, wherein the single values depend on the power factors of a period of time.

In one embodiment of the method, single values are used to form, for example by calculation, the monitoring value, i.e. in particular a multiplicity of single values that will be or are determined in a steady operating state of the synchronous motor are used. A steady operating state of the synchronous motor is, for example, an operating state in which the rotational speed, in particular the target rotational speed, of the synchronous motor changes only slightly. A slight change in the rotational speed, for example, occurs when the revolutions change by less than 10 revolutions/min within 1 minute. Another example of a slight change in the rotational speed is when the speed changes by less than 1 percent within 1 minute.

In one embodiment of the method, single values that will be or are determined in a dynamic operating state of the synchronous motor are excluded in order to form the monitoring value. A dynamic operating state is, for example, the start-up of the electric motor or the shut-down of the synchronous motor. A dynamic operating state of the synchronous motor is present, for example, when the rotational speed of the synchronous motor changes by more than 10 revolutions/minute within 1 minute. A further example of a dynamic operating state is a rotational speed change of more than 1 percent within 1 minute. The synchronous motor is characterized in particular by the fact that different target rotational speeds and/or different loads are provided during operation.

When monitoring the synchronous motor, it is particularly important not to monitor the cos φ absolutely using limit values, since the cos φ can take on different values at different operating points, such as in dynamic operating states. For the monitoring at hand, it can be important how the power factor develops or changes over time in steady states.

In one embodiment of the method, the synchronous motor has different target rotational speeds during operation. According to the method, it is therefore possible to monitor how the power factor develops over time at different target rotational speeds in steady operating states. In particular, a synchronous motor must be kept in an optimal operating state in terms of energy. To do this, the power factor must be monitored. In the case of a synchronous motor, an optimal use in terms of energy is achieved at a cos φ equal to 1.

In one embodiment of the method, the multiplicity of single values is taken from a period of time, which in particular can be freely determined, wherein the period of time has in particular a length of at least one minute or has a length of minutes to months. The time interval of the single values used within the period of time can, for example, be one or more seconds (in particular, therefore, greater than one second) or one or more minutes (in particular, therefore, greater than one minute). In particular, the interval is adjustable. For example, the interval is between 10 and 120 seconds. In this case, only single values that were determined in a steady operation of the synchronous machine or synchronous motor are taken into account.

In one embodiment of the method, a weighting is carried out according to time in the formed monitoring value. The monitoring value can therefore be formed from a sum of values, wherein the values are weighted differently depending on their age. For example, if a first value Wn and a second value Wn+1 are given, a new value can be formed by a forgetting factor alpha: Monitoring value=Wn+1+(Wn*(1−Alpha)), wherein alpha is less than 1.

In one embodiment of the method, single values are used depending on the operating state of the synchronous machine or the synchronous motor. Power factors are therefore in particular not taken into account if these are determined, for example, during a run-up of the synchronous machine or synchronous motor. In particular, power factors are taken into account if these were determined in a steady state of the synchronous machine or synchronous motor.

However, this evaluation requires expert knowledge, since the power factor deviates from the target value in many operating states. This is caused, for example, by the motor starting and stopping, load changes, procedural changes in the rotational speed target values. These operating conditions must be included in the evaluation.

In one embodiment of the method, an anomaly is identified by the monitoring value, wherein the anomaly in particular relates to the excitation facility. This way, a defective excitation facility can be identified, for example.

In one embodiment of the method, the rotational speed of the synchronous machine or synchronous motor is also taken into account when recording the single values. For example, the power factor can be multiplied by the sign of the motor rotational speed. This way, monitoring is dependent on the rotational speed.

In one embodiment of the method, the power factor of the synchronous motor is improved after identifying the anomaly. This can be achieved, for example, by optimizing the closed-loop control of the excitation facility or by replacing or repairing a component, such as a defective power semiconductor valve or a closed-loop control module, etc. In one embodiment, the optimization achieves a cos φ of 1 again.

In the case of a monitoring facility of a synchronous machine or synchronous motor, the monitoring facility is integrated in a component of a power converter or in a component of a closed-loop control and/or open-loop control system of the synchronous machine or synchronous motor, in particular for monitoring an excitation facility of the synchronous machine or synchronous motor, wherein the monitoring facility can be used to perform one of the described methods. The component of the power converter is, for example, a control cabinet or a housing. The component of the closed-loop control and/or open-loop control system is, for example, a housing or a printed circuit board.

A computer program product features a program for performing one of the described methods, wherein the computer program product is particularly capable of running on the monitoring facility.

In the following, the invention will be illustrated and explained by way of example in more detail with the aid of a FIGURE.

According to the invention, continuous and context-related monitoring of the power factor is possible. The flow chart illustrates possible individual steps and highlights possible advantages over the previous manual solution to the problem (manual expert monitoring or limit value observation). According to the invention, all of the steps described below can be performed, or just one step or just a selected part of the steps described below:

### Step

### Preprocessing 1:

### Multiply the New Power Factor by the Sign of the Motor Rotational Speed—

In the first step, the prevailing power factor is multiplied by the sign of the motor rotational speed. This guarantees that negative power factors are not mistakenly identified as faulty. Compared to the previous solution, additional measurement values are taken into account here, which reduces the ‘false positive’ rate (‘false positive’ rate: points in time that are incorrectly classified as abnormal and thus unnecessarily attract attention).

### Step

### Filter 2:

Consider Only Time Stamps in which the Machine, Such as the Synchronous Motor, is Operated in a Steady State—
In the second step, only relevant time stamps of individual values are filtered. In particular, measurement values (single values) that lie a certain period of time away from the next off-state are considered irrelevant.
Periods of time during which the machine is not running (including, for example, start-up and shut-down times) are not included in the analysis, thus reducing the false positive rate. Unlike the previous solution to the problem, additional information is taken into account and the power factor is considered in the overall context, rather than just classifying its raw values.

### Step

### Error Sum 3:

Add the Deviation of the Power Factor to the Total Error Sum, which is Multiplied Beforehand by a Forgetting Factor (Alpha)—
After data preparation, the error (difference between the actual power factor and the expected value 1) is added to a total error sum. This is multiplied beforehand by a forgetting factor (α<1), wherein previous errors are weighted less heavily. This means that the total error sum decreases again over time and past errors are not carried forward permanently.

### Step

### Limit Value 4:

### Identify an Anomaly Using a Total Error Sum—

If the error sum exceeds a certain value, the point in time is classified as abnormal. Individual measurement errors are not classified as abnormal. Instead, the errors are added up and an anomaly is only identified when a limit is exceeded. This approach ensures a reduction in the false positive rate. An anomaly is only identified when an accumulation of unexpected performance factors occurs. In addition, larger deviations carry more weight because the error total increases more quickly in the case of larger deviations.

### Step

### Maximum Error Sum 5:

Make Sure that the Error Sum does not Exceed a Maximum—
The error sum is limited to a maximum. This ensures that it does not become too large and that a replacement of the defective excitation facility is established promptly. The forgetting factor reduces the error sum during normal operation, whereby the status is automatically set to normal after a sufficient number of normal measured values.

One advantage of the invention is that, for example, after a repair of an excitation facility, no manual entry of the repair has to be made. After a while, the algorithm automatically recognizes the change based on the data.

The described features result in an automated monitoring of the power factor. A context-related error sum (for example by only using values in a steady operation) is used to ignore outliers in particular, recognize accumulations and dynamically determine changes.

1.-12. (canceled)

13. A method for monitoring a synchronous motor, the method comprising:
measuring a single value dependent on a power factor of the synchronous motor; and
forming a monitoring value from a multiplicity of single values and/or dependent values.

14. The method of claim 13, further comprising monitoring an excitation facility of the synchronous motor.

15. The method of claim 13, wherein single values that will be or are determined in a steady operating state of the synchronous motor are used in order to form the monitoring value.

16. The method of claim 13, wherein single values that will be or are determined in a dynamic operating state of the synchronous motor are excluded in order to form the monitoring value.

17. The method of claim 13, wherein the synchronous motor has different target rotational speeds during operation.

18. The method of claim 13, further comprising taking the multiplicity of single values from a period of time.

19. The method of claim 18, wherein the period of time is freely determinable and has a length of at least one minute or a length of minutes to months.

20. The method of claim 13, further comprising carrying out a weighting according to time when forming the monitoring value.

21. The method of claim 13, wherein single values dependent on an operating state of the synchronous motor are used.

22. The method of claim 13, further comprising identifying an anomaly by the monitoring value.

23. The method of claim 22, wherein the anomaly relates to an excitation facility of the synchronous motor.

24. The method of claim 22, further comprising improving the power factor of the synchronous motor after identifying the anomaly.

25. The method of claim 22, wherein the anomaly relates to an excitation facility of the synchronous motor, the method further comprising improving the power factor by optimizing a closed-loop control of the excitation facility.

26. The method of claim 22, wherein the anomaly relates to an excitation facility of the synchronous motor, the method further comprising improving the power factor by repairing or replacing a component of the excitation facility.

27. The method of claim 13, further comprising taking into account a rotational speed of the synchronous motor with the single values.

28. A monitoring facility of a synchronous motor, wherein the monitoring facility is integrated in a component of a power converter or in a component of a closed-loop control and/or open-loop control system of the synchronous motor, wherein the monitoring facility is designed to perform the method set forth in claim 13.

29. The monitoring facility of claim 28, wherein an excitation facility of the synchronous motor is monitored.

30. A computer program product, embodied as a non-transient computer readable medium, comprising a program for performing the method set forth in claim 13 when running on a monitoring facility of a synchronous motor.
